(19) United States
(12) Patent Application Publication
(10) Pub. No.: US 2007/0003228 A1
(43) Pub. Date: Jan. 4, 2007

(54) Video image recording/playback apparatus

(76) Inventors: Yuuichi Togashi, Tokyo (JP); Yoshihiro Katayama, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/476,785

(22) Filed: Jun. 29, 2006

(30) Foreign Application Priority Data
Jun. 30, 2005 (JP) 2005-193162

(51) Int. Cl. H04N 7/00

(52) U.S. Cl. 386/95

(57) ABSTRACT

To provide a video image recording/playback apparatus configured to change a SKIN design interlocking with setting and states of an apparatus, and a method of changing an image pattern display, having a signal processor which superposes a signal of image pattern peculiar to an application and user interface on a video display output signal from an output means for outputting a video display output signal to display an image, and changing freely a design and background design displayed in a function setting screen, when a change of image pattern is instructed from a remote control terminal, for example.

### CROSS-REFERENCE TO RELATED APPLICATIONS

This application is based upon and claims the benefit of priority from Japanese Patent Application No. 2005-193162, filed Jun. 30, 2005, the entire contents of which are incorporated herein by reference.

### BACKGROUND

1. Field

One embodiment of the invention relates to a video image recording/playback apparatus configured to change a SKIN design interlocking with setting of apparatus, and a method of changing an image pattern display.

2. Description of the Related Art

Menu and setting screens displayed in a video image recording/playback apparatus connected to a personal computer, video camera or television set having a monitoring unit capable of displaying an image can be changed based on the user's favorite. Display of various startup screens (splash) is proposed by a supplier of playback object data or a connected apparatus.

For example, Japanese Patent Application Publication (KOKAI) No. 2001-325768 discloses changing of a menu screen design interlocking with a change in playback style (audio volume, equalizer, etc.).

However, changing of the designs of startup screen and setting item display screen of an apparatus is not considered in the above Publication. Therefore, the disclosed change does not always meet the favorite of each user, and product differentiation is difficult.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a SKIN function in a video apparatus in accordance with an embodiment of the invention;

FIG. 2 is an exemplary block diagram showing an example of a recording/playback apparatus;

FIG. 3 is an exemplary flowchart of changing, getting, displaying a list, registering and managing of SKIN;

FIG. 4 is an exemplary diagram showing an example of display of SKIN destination select screen;

FIG. 5 is an exemplary flowchart of displaying a SKIN list select screen;

FIG. 6 is an exemplary diagram showing an example of SKIN management data;

FIG. 7 is an exemplary diagram showing an example of a screen for returning a changed SKIN to an original;

FIG. 8 is an exemplary flowchart of automatically changing SKIN based on the SKIN management data and apparatus setting information;

FIG. 9 is an exemplary flowchart of automatically changing SKIN based on the SKIN management data and apparatus states; and

FIG. 10 is an exemplary flowchart of changing a SKIN design.

### DETAILED DESCRIPTION

Various embodiments according to the invention will be described hereinafter with reference to the accompanying drawings. In general, according to one embodiment of the invention, a video image recording/playback apparatus configured to change a SKIN design interlocking with setting and states of an apparatus, and a method of changing an image pattern display, having a signal processor which superposes a signal of image pattern peculiar to an application and user interface on a video display output signal from an output means for outputting a video display output signal to display an image, and changing freely a design and background design displayed in a function setting screen, when a change of image pattern is instructed from a remote control terminal.

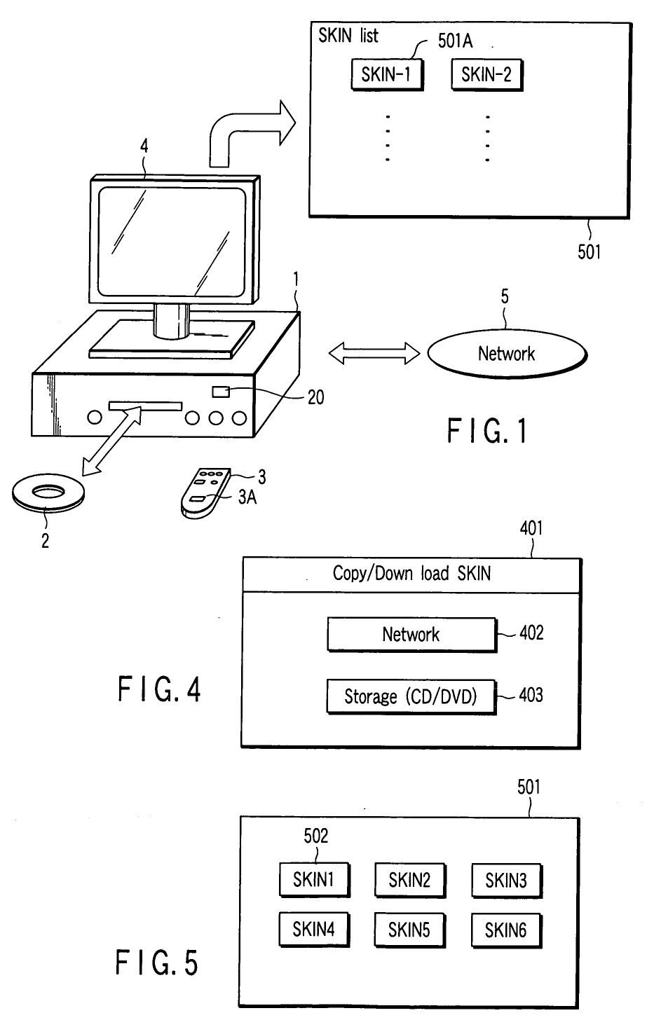

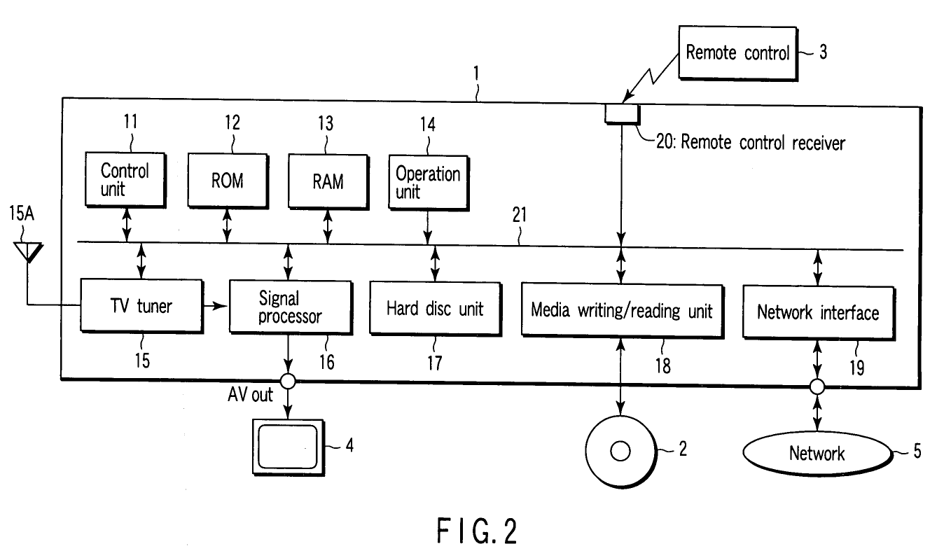

According to an embodiment, FIG. 1 schematically shows a SKIN function in a video apparatus according to the invention. SKIN indicates a scheme to change the appearance (screen) by an image to UI (user interface) of an application, or a sticking image itself. Namely, in FIG. 1, the invention relates to an image displayed in a video apparatus (display unit) connected or constructed integrally with a recording/playback apparatus 1. FIG. 2 is a schematic block diagram explaining the structure of the recording/playback apparatus 1 and video unit 4 shown in FIG. 1.

The recording/playback apparatus 1 includes a control unit 11, a ROM 12, a RAM 13, an operation unit 14, a TV tuner 15, a signal processor 16, a hard disc unit 17, a media writing/reading unit 18, a network interface 19, and a remote control receiver 20. These components are connected through a data bus 21. The TV tuner 15 is connected with an antenna 15A to receive public broadcasting, though not described in detail. The signal processor 16 is provided with an AV out (output terminal), and connected with the video unit (display unit) 5.

The control unit 11 includes a microcomputer, for example, and controls the operations of the above components (circuits) of the recording/playback apparatus 1.

The ROM 12 stores a program executed by the control unit 11 and information necessary for initialization. The ROM 12 is a rewritable memory element, which holds stored contents even if the power of the apparatus 1 is turned off.

The RAM 13 holds (stores) data referenced by the control unit 11 when executing operations, or data created by the control unit 11 during operations.

The operation unit 14 includes operation elements (buttons and switches) provided in the main body of the recording/playback apparatus 1. When an optional button or switch of the operation unit 14 is operated, a control signal is input to the control unit 11 for execution of a required control operation. The operation unit 14 can be operated parallel to a control signal input from the remote control terminal 3 through the remote control receiver 20.

The TV tuner 15 receives broadcasting waves from a broadcasting station or satellite through the antenna 15A, and tunes a channel according to the instruction from the control unit 11. The received broadcasting wave is output to the signal processor 16 as stream data, for example.

The signal processor 16 extracts data of a required program (channel) from the input stream data, according to the user's demand, provides compressed video data (hereinafter indicated simply as video data) and compressed audio data (indicated simply as audio data), for example. The provided video and audio data are transferred to the hard disc unit 17 for recording, for example, under the control of the control unit 11, and recorded in a not-shown built-in hard disc. The recording destination may be a recording medium 2 set in the media writing/reading unit 18. The writing/reading unit 18 is an optical disc unit, and uses a DVD disc (optical disc) as a recording medium 2. The writing/reading unit 18 may be a fixed memory (not shown) capable of recording and playing back an image in/from a semiconductor memory (memory card).

The signal processor 16 includes a video interface (Video I/F), an On Screen Display (OSD) processor, and a video decoder (not described in detail), and generates an image signal or a video signal for a display output. Therefore, displays of a SKIN image and various displays during changing of SKIN image are output from the signal processor 16 to the display unit (video unit) 5 through the AV out.

The network interface 19 can obtain desired data when connected to a network 5 used widely (not described in detail). When the user demands, the network interface can send predetermined data to a not-shown information supplier (homepage of a manufacturer of the apparatus 1, external server, etc.) connected to the network 5. The network interface 19 may be either a wireless type or wired type.

The data obtained by the network interface 19 is processed by unpacketting for example in the network interface 19, and converted to a format processable by the recording/playback apparatus 1. The data obtained in this way is transferred to a necessary element of the recording/playback apparatus 1 through the data bus 21, and stored if necessary.

In the recording/playback apparatus 1, when playback of a recorded image is instructed from the operation unit 14 or remote control terminal 3, the instructed record file among the record files stored in the hard disc unit 17 is searched under the control of the control unit 11. The record file instructed to playback is output to the signal processor 16, and decoded (expanded) by the signal processor 16. Then, the video image signal and audio signal corresponding to video data are obtained.

The video image signal and audio signal are output to the AV output terminal (AV out), and supplied to the video unit 4 connected to the output terminal. Then, the audio signal (sound) corresponding to the video image as a recorded program is output.

The hard disc unit 17 includes a large capacity hard disc, and a driver to write or read data in/from a hard disc. A hard disc is controlled by a compression rate as well known. For example, when a current television broadcasting is compressed at an average compression rate, a hard disc can record a video image (program or title) of several hundreds hours. The data read from the recording medium 2 set in the media writing/reading unit 18 can also be saved in the hard disc unit 17. An application program executed by the control unit 11 can also be stored in the hard disc.

The media writing/reading unit 18 can read video or SKIN data recorded in the set recording medium 2, and transfer it to the hard disc unit 17 or RAM 13.

In the recording/playback apparatus 1 and display unit 4 described above, when SKIN data is read from the recording medium 2, a SKIN list select screen 501 (refer to FIG. 1) obtained from the recording medium 2 is displayed in the video unit (display unit) 5. The SKIN data can also be obtained through the network 5.

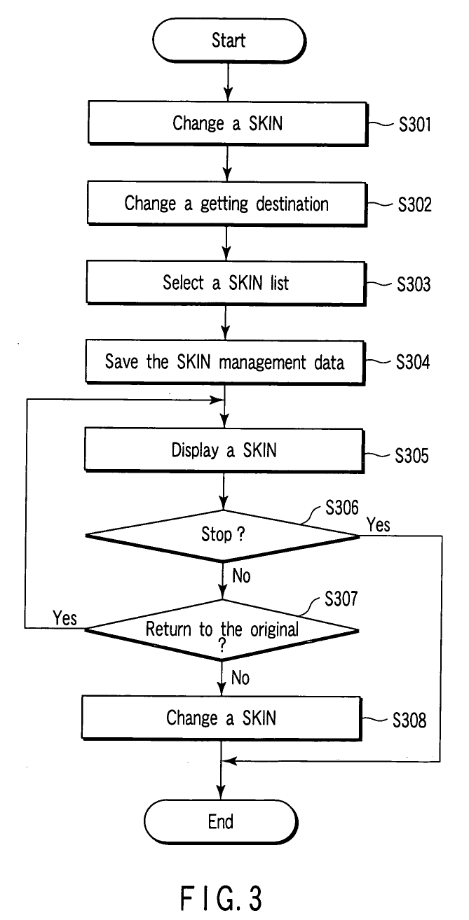

FIG. 3 is a flowchart of changing, grabbing, displaying a list, registering and managing of SKIN.

When the SKIN changing is instructed (selected) in step S301, a SKIN destination select screen 401 (refer to FIG. 4) is displayed in the display unit 4 (step S302). The destination select (change) screen displays GUI display 402 of buttons or icons to instruct a network (web), and GUI display 403 of buttons or icons to instruct media represented by CD-ROM and DVD-R.

When the GUI display 402 or 403 is selected by the operation from the remote control terminal 3, for example, in step S302, the SKIN list select screen 501 (refer to FIG. 5) to display a list of SKIN images held in the corresponding SKIN image supplier is displayed (step S303). When the SKIN list select screen 501 is displayed, the SKIN data of the SKIN design (*) displayed parallel to, in the background of, just before, or as SKIN of the screen 501 is recorded in a predetermined system area (ROM 12 or HDD 17) (step S304).

Next, when an optional SKIN design (n) is selected from the SKIN list select screen 501 displayed in step S303 by the operation from the remote control terminal 3, for example, the corresponding SKIN image data (n) is read from the supplier and the display of the display unit 4 is changed (step S305).

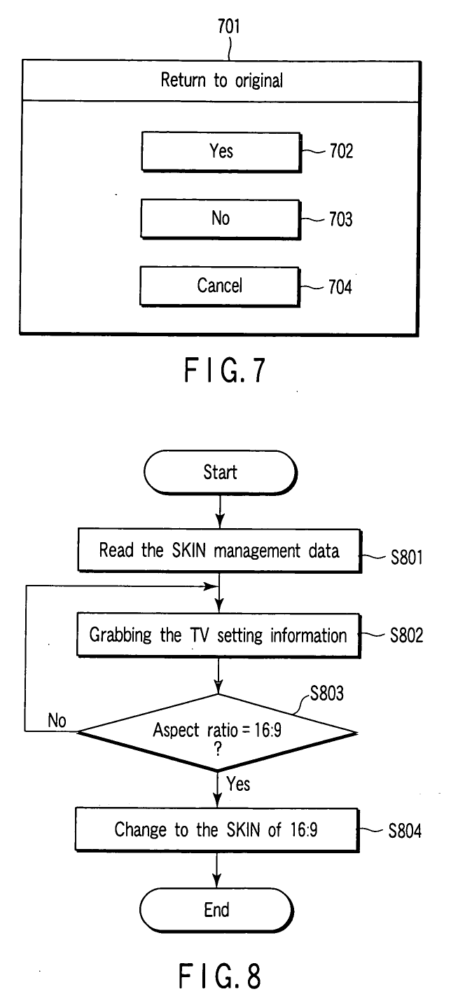

Then, or after a predetermined time, a SKIN design set screen 701 (refer to FIG. 7) is displayed, to determine whether the SKIN image displayed in step S305 is set, or the changing of SKIN image is cancelled (step S306). The SKIN design set screen 701 includes GUI to instruct whether to return the SKIN screen to the original state, for example, GUI display 702 of a “YES (return to the original SKIN)” button or icon, GUI display 703 of a “NO (use the previously selected SKIN)” button or icon, and GUI display 704 of a “CANCEL (stop the changing of SKIN)” button or icon.

When the GUI display 704 (“Cancel”) is instructed in step S306 (S306-Yes), the SKIN changing is stopped and returned to the original display.

When the GUI display 703 (“No”) is instructed in step S307 and the change to the SKIN (n) newly read (going to be changed) is instructed from the remote control terminal 3 (S507-Yes), the SKIN design of the display unit 4 is changed to the SKIN (n) displayed now and the SKIN management data is rewritten (S308).

Contrarily, when the GUI display 702 (“Yes”) is selected in step S307 (S507-No), the SKIN image of the display unit 4 is returned to the SKIN (*) displayed up to that time. In this case, the related information is also returned to the original state.

When the optional SKIN design (n) is selected by the user by operating the remote control terminal 3, the current SKIN design (*) of the display unit 4 is changed to the selected SKIN design (n) based on the obtained SKIN information (SKIN (n)). When the SKIN design is changed, the changed contents are checked (confirmed), necessary information is taken out, and the changed data is saved.

The above SKIN design change can be combined optionally with the design of the screen used for initialization and the design of the background screen. The startup screen (splash) can also be changed. Namely, the user's favorite SKIN design (n), for example, tropical (SKIN 2), pastel (SKIN 3) and classic (SKIN 5), . . . , SKIN 6 (specific SKIN) can be set at any time.

Before the management data of the changed SKIN (n) is recorded, the management data used for returning to the current SKIN (*) is recorded. This permits a different user to set (automatically change) a preferential SKIN design when the user want to use a specific SKIN design, or to correlate to various conditions of a specific work or use of application.

The setting (automatic change) of a preferential SKIN design is also possible when a playback source is different, for example, a video image recorded in the HDD 17 and information from the media writing/reading unit. By setting a screen (SKIN) preferentially for a function used frequently, a screen (SKIN) can be efficiently displayed for audio output and subtitle or for different users, for example.

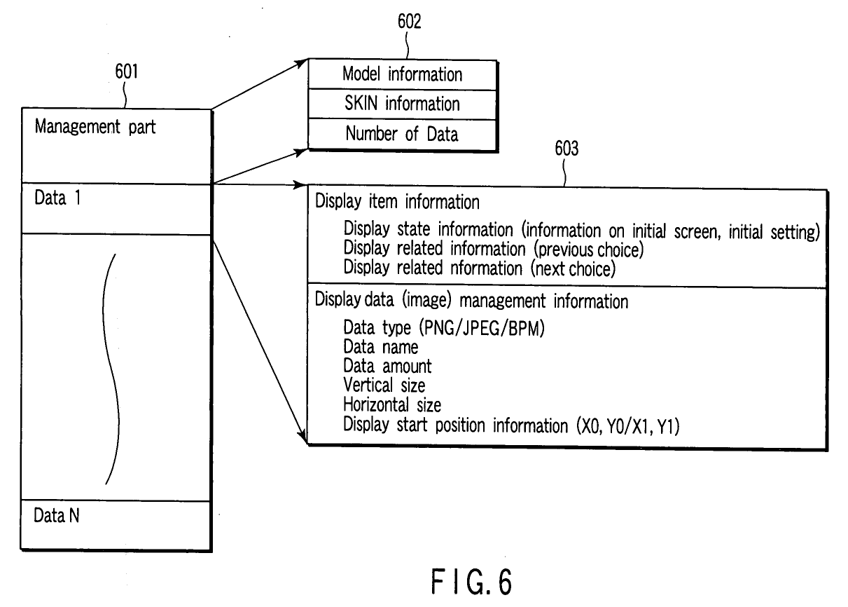

FIG. 6 is a schematic diagram explaining an example of SKIN management data. The SKIN management data includes a management part 602 for recording information about models, SKIN information and number of data, and a data description part 603 prepared for each data (1 to n). The description part for each data includes display item information including “displayed state information (initial screen, initial setting)”, “display related information (previous choice)” and “display related information (next choice)”, and display data (image) management information including “type of data (file format, PNG, JPEG, BPM)”, “data (file) name”, “data amount (size)”, “vertical size”, “horizontal size” and “display start position information (X0=horizontal start point, Y0=vertical start point, X1=horizontal end point, Y1=vertical end point)”.

The SKIN management data 601 shown in FIG. 6 is created to manage information necessary for displaying a SKIN image, and read from a storage unit (ROM 12 or HDD 17) to a work memory (RAM) 13 under the control of the control unit 11 when the recording/playback apparatus 1 is started.

Based on the SKIN management data, a SKIN screen for startup or a SKIN screen for setting of functions is displayed. The SKIN management data includes the timing (condition) of starting (automatic change) that SKIN. Therefore, the SKIN design can be set (automatically changed) for different users, applications, or playback sources, such as a video image recorded in the HDD 17 and information from the media writing/reading unit. The timing of automatic change will be explained below. For example, screen size information can be used. Usable information includes the types and standards of media set in the media writing/reading unit, load/unload of media, and login for each user.

FIG. 8 is a flowchart showing an example of automatically changing a SKIN design by the SKIN management data 601 shown in FIG. 6 and apparatus setting information. In FIG. 8, a SKIN design is automatically changed according to the screen size (aspect ratio) of the display unit 4.

First, the SKIN management data 601 is read (step S801). Then, the setting information of a display unit (television unit) 5 is read (step S802).

Next, whether the aspect ratio (TV screen shape) is 16:9 is judged (step S803). When the aspect ratio is 16:9 in step S803 (S803-Yes), the previously related SKIN design of 16:9 is read, and the screen is changed (step S804).

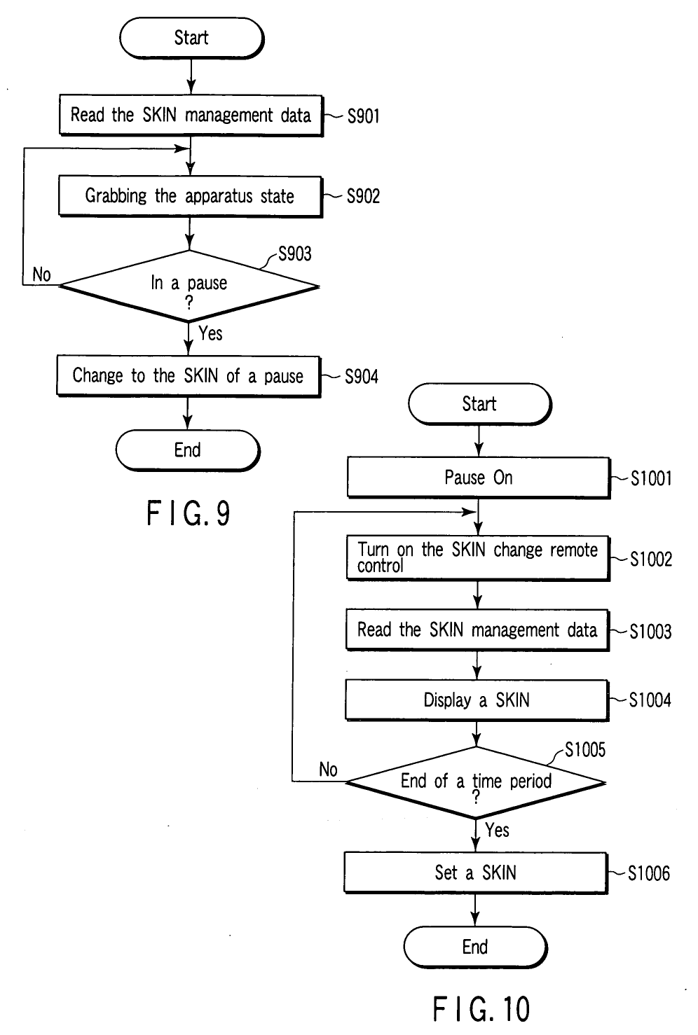

FIG. 9 is a flowchart showing an example of automatically changing a SKIN design by the SKIN management data 601 shown in FIG. 6 and apparatus setting information.

First, the SKIN management data 601 is read (step S901). Then, the setting state (operation state) of the recording/playback apparatus is checked (step S902). The operation state is to be a pause during recording of a video image.

Next, whether the operation state is a pause is judged (step S903). When the operation state is a pause (S903-Yes), a SKIN for a pause is selected (step S904). The changing of SKIN image for a pause during recording is certainly noticeable to the user, and a failure in resetting the pause (missing the timing to return to the recording) is prevented.

FIG. 10 is a flowchart showing an example of actually changing a SKIN design. In FIG. 10, the SKIN design during a pause is changed by one operation of the SKIN change button (operation element) of the remote controller terminal.

When changing the pause SKIN, first set a pause in a displayed image by a not-shown pause key (button) during recording or playback of the video image (step 1001).

When a pause is set in step 1001, the SKIN change button 3A of the remote control terminal 3 (refer to FIG. 1) is turned on while the SKIN image for a pause is being displayed (step S1002), the SKIN management data 601 explained in FIG. 6 is read from the SKIN data record destination (step S1003).

Then, a SKIN image registered as a next choice of SKIN for a pause is displayed in the display unit 4 (step S1004). When the state that the SKIN change button 3A is not turned for a predetermined time is detected (step S1005-Yes), the current SKIN image is set as a SKIN image for a pause (step S1006). If the SKIN change button 3A is continually turned on (step S1005-No), a SKIN image registered as a next choice in step S1004 is displayed on the display unit.

As explained hereinbefore, according to the invention, the design and background design displayed in the startup screen (splash) and function setting screen of a recording/playback apparatus can be freely changed. For example, a favorite design can be used for each user. It is possible to set a design capable of easily confirming that a preferential function (used frequently) has been executed. Moreover, it is unnecessary to modify a program to follow changes in a displaying design (including a size) and displaying position.

Therefore, an image design can be easily changed interlocking with the states and setting of an apparatus. The easy change of displayed design is effective for differentiation of OEM (Original Equipment Manufacturing) products.

The above described invention is applicable not only to a TV set, but also apparatus capable of displaying an image, such as a monitor unit and video camera.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video image recording/playback apparatus comprising:
an output means for outputting a video display output signal to display an image;
a signal processing means for superposing a signal of image pattern peculiar to an application or user interface on an image display output signal from the output means; and
a change instruction means for instructing the signal processing means to change an image pattern.

2. The video image recording/playback apparatus according to claim 1, wherein the change instruction means instructs a change of screen pattern, based on screen size information included in a video signal which is an object of display as an image display output signal.

3. The video image recording/playback apparatus according to claim 1, wherein the change instruction means instructs a change of screen pattern, when a change of screen pattern is externally instructed.

4. The video image recording/playback apparatus according to claim 1, wherein the signal processing means holds image pattern information superposed on a display output until one of change and cancellation of screen pattern is determined, when a change of screen pattern is instructed from the change instruction means.

5. The video image recording/playback apparatus according to claim 1, wherein the change instruction means instructs a change of screen pattern, when a video supplier is changed and a change of screen pattern is instructed.

6. A method of changing an image pattern display of a video image recording/playback apparatus, comprising:
superposing a signal of image pattern peculiar to an application or user interface on a video display output signal output to a video display apparatus configured to display an image; and
changing a video display output signal to a menu screen output signal to display a menu screen configured to instruct a change of image pattern.

7. A method of changing an image pattern display of a video image recording/playback apparatus according to claim 6, further comprising:
holding image pattern information superposed on a display output until one of change and cancellation of screen pattern is determined, when a change of screen pattern is instructed.

8. A method of changing an image pattern display of a video image recording/playback apparatus, comprising:
outputting a signal of image pattern peculiar to an application or user interface together with a video display output signal output to a video display apparatus configured to display an image; and
displaying a menu screen to accept a change of image pattern configured to select a supplier of an object image pattern, when a change of image pattern is instructed.

9. The method of changing an image pattern display of a video image recording/playback apparatus according to claim 8, further comprising:
holding image pattern information superposed on a display output until one of change and cancellation of screen pattern is determined, when a change of screen pattern is instructed.
